(19) United States
(12) Patent Application Publication
(10) Pub. No.: US 2023/0105661 A1
(43) Pub. Date: Apr. 6, 2023

(54) LOCKING BALL AND SOCKET JOINT

(71) Applicant: Daniel A. Delzer, Sarasota, FL (US)

(72) Inventor: Daniel A. Delzer, Sarasota, FL (US)

(21) Appl. No.: 17/495,220

(22) Filed: Oct. 6, 2021

(51) Int. Cl. F16C 11/06

(52) U.S. Cl. CPC F16C 11/0638; F16C 11/069; F16C 11/0604

(57) ABSTRACT

A ball and socket joint (1) having non-smooth interlocking surfaces (15) wherein projections (8) and corresponding voids (7) mate when the socket (9) and ball (2) are clamped together to prevent the ball from slipping out of position while the ball and socket joint is in use and under pressure.

### FIELD OF THE INVENTION

This invention generally relates to interlocking joints used in mounting systems and more particularly, to a ball and socket joint having interlocking surfaces that prevent the ball from slipping out of a locked position within the socket.

### BACKGROUND OF THE INVENTION

Ball and socket joints are commonly used for mounting and supporting a variety of objects in selective positions, such as cellphones, tablets, video displays, speakers, cameras, microphones, and other electronic devices. A conventional ball and socket joint typically includes a spherical-shaped ball or “male portion” that is inserted into a concave-shaped socket or “female portion” and locked into position using a clamping mechanism that compresses the socket around the ball. The action of the socket compressing an inner surface of the socket against an outer surface of the ball creates a friction fit that prevents the ball from moving within the socket.

Conventional ball and socket joints typically have smooth surfaces to allow the ball to be easily angled and rotated in relation to the socket. However, smooth surfaces are prone to slippage and failure over time especially when supporting heavier objects and/or objects that are in motion.

Therefore, a need exists for a ball and socket joint having interlocking surfaces that prevent the ball from slipping out of a locked position within the socket.

### SUMMARY OF THE INVENTION

The primary object of the present invention is to provide a ball and socket joint having interlocking surfaces that prevent the ball from slipping out of a locked position within the socket.

The present invention fulfills the above and other objects by providing a ball and socket joint having non-smooth interlocking surfaces wherein projections and corresponding voids are located on an inner surface of the socket and on an outer surface of the ball. The projections and voids engage each other when the socket and ball are clamped together, thereby preventing the ball from slipping out of position while in use and under pressure.

For example, the interlocking surfaces of the ball and socket joint may include one or more dimple-shaped projections located on the inner surface of the socket and a corresponding plurality of dimple-shaped voids located on an outer surface of the ball. The dimple-shaped voids and projections press together when the socket is clamped against the ball, thereby locking the ball within the socket.

The interlocking surfaces of the present invention may include any corresponding geometric pattern that creates an uneven seam between the two interlocking surfaces. For example, the interlocking surfaces of the ball and socket joint may include voids and projections shaped like ridges wherein in the opposing ridges mate with each other regardless of the position of the ball within the socket.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a side view of a ball and socket joint of the present invention;

FIG. 2 is a top view of the ball and socket joint of the present invention;

FIG. 3 is a front view the ball and socket joint of the present invention;

FIG. 4 is a sectional front view along lines A-A of FIG. 3;

FIG. 5 is a detailed view along lines B-B of FIG. 4;

FIG. 6 is a side view of a ball and socket joint of the present invention having grooves that interlock with the protrusions in the inner surface of the socket;

FIG. 7 is an exemplary view of a ball and socket joint of the present invention in use with a microphone stand;

FIG. 8 is a detailed view along lines C-C of FIG. 7;

FIG. 9 is an exemplary view of ball and socket joints of the present invention in use with a digital display; and

FIG. 10 is an exemplary view of ball and socket joints of the present invention in use with an elongated support arm holding a camera in an elevated position.

### DESCRIPTION OF THE PREFERRED EMBODIMENTS

For purposes of describing the preferred embodiment, the terminology used in reference to the numbered accessories in the drawings is as follows:

1. ball and socket joint, generally

2. ball

3. body

4. base

5. attachment means

6. outer surface of ball

7. void

8. projection

9. socket

10. inner surface of socket

11. clamping means

12. nut

13. bolt

14. ridge

15. interlocking surface

16. leg

17. arm

18. digital display

19. camera

20. microphone stand

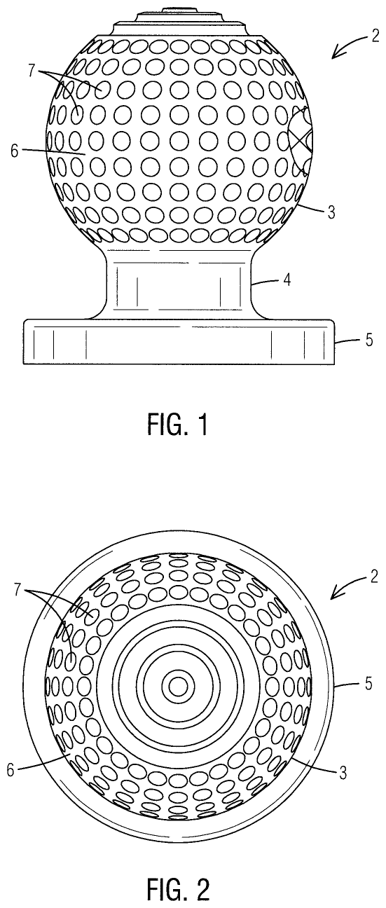

With reference to FIGS. 1 and 2, a side and top view, respectively, of a ball 2 of the ball and socket joint 1 of the present invention is illustrated. The ball 2 of the present invention comprises a spherical-shaped body 3 extending from a base 4 and/or attachment means 5 used for securing the body 3 and/or base 4 to a secondary object or surface. The body 3 further comprises an outer surface 6 of the ball 2 having at least one void 7 and/or at least one projection 8 located thereon. As illustrated herein, the outer surface 6 of the body 3 has a plurality of concave dimple-shaped voids 7.

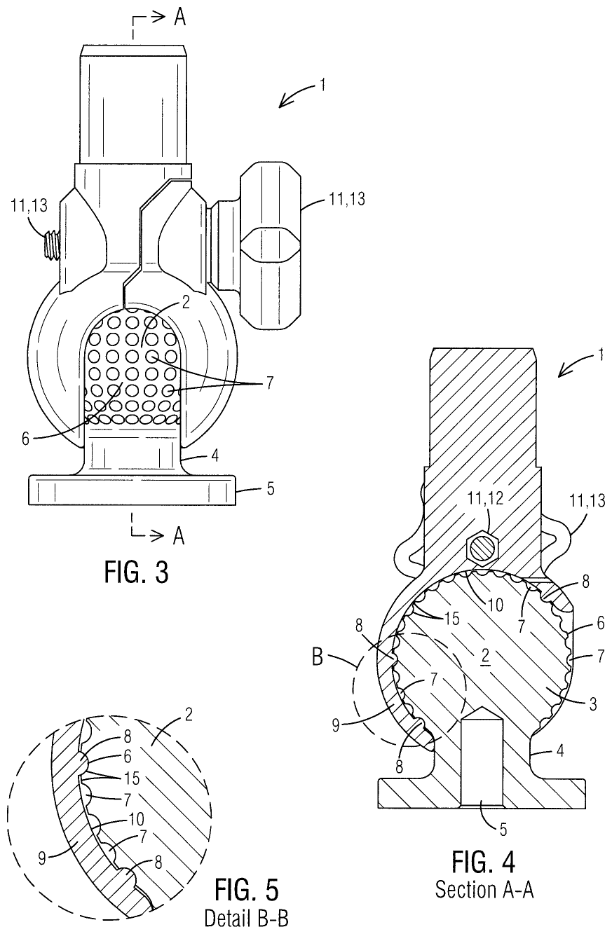

With reference to FIGS. 3-5, a front view, sectional front view, and a detailed view, respectively of a ball and socket joint 1 of the present invention is illustrated. The ball and socket joint 1 comprises a ball 2 inserted into a concave-shaped socket 9. The outer surface 6 of the body 3 of the ball 2 has a plurality of concave dimple-shaped voids 7. An inner surface 10 of the socket 9 has at least one corresponding dimple-shaped projection 8 located thereon that engages at least one of the plurality of concave dimple-shaped voids 7, as shown in FIG. 5, to form interlocking surfaces 15.

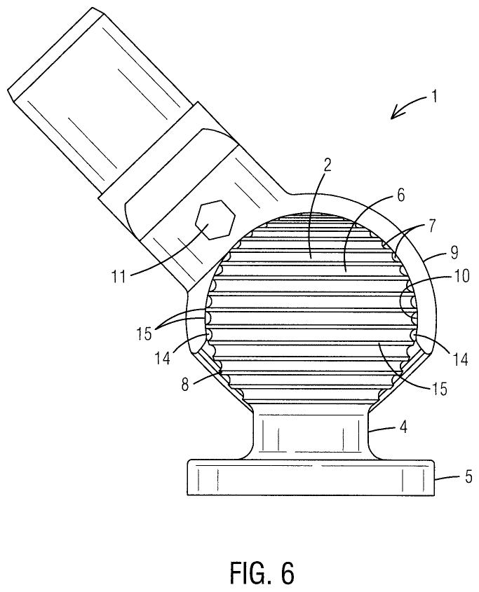

The socket 9 further comprises a clamping means 11, such as a nut 12 and bolt 13, screws, and so forth, located thereon to tighten and reduce the circumference of the socket 9, thereby forcing the projections 8 and voids 7 to engage to prevent the ball 2 from slipping out of position while the ball 2 of the ball and socket joint 1 is in use and under pressure. With reference to FIG. 6, a side view of a ball and socket joint 1 of the present invention having grooves 14 is illustrated. The outer surface 6 of the body 3 has a plurality of grooves 14 that form voids 7 and projections 8 thereon. The socket 9 has projections 8 that interlock with the grooves 14 on the ball 2 allowing the horizontal angle to be fixed but allow for the 360-degrees rotation about the vertical axis, while the ball 2 and the socket joint 1 is in use and under pressure.

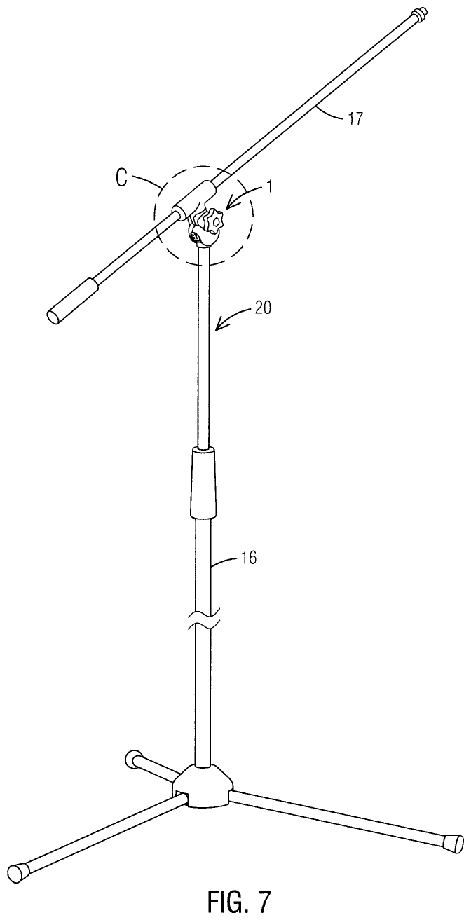

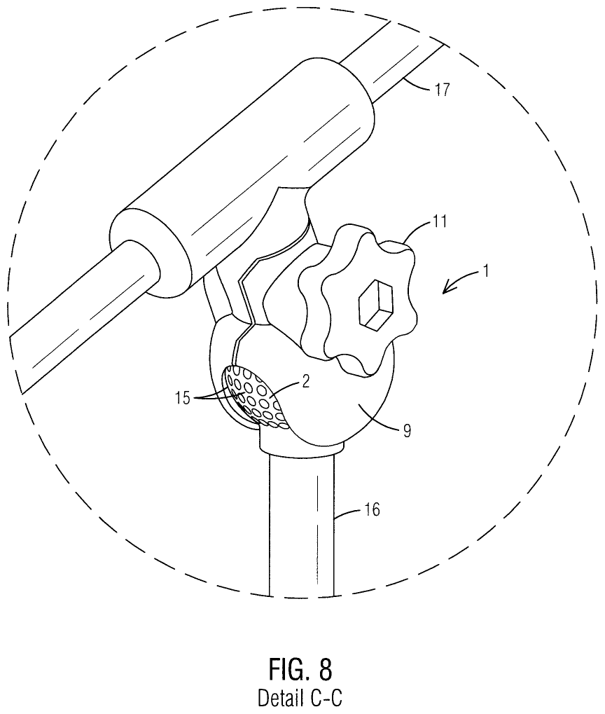

With reference to FIGS. 7 and 8, exemplary views of a ball and socket joint 1 of the present invention incorporated into a microphone stand 15 is illustrated. The ball 2 is located on top of an elongated vertical leg 16 and engages a socket 9 located on a support arm 17. The interlocking surfaces 15 and clamping means 11 allow the arm 17 to be angled and rotated into multiple positions and then securely locked into position.

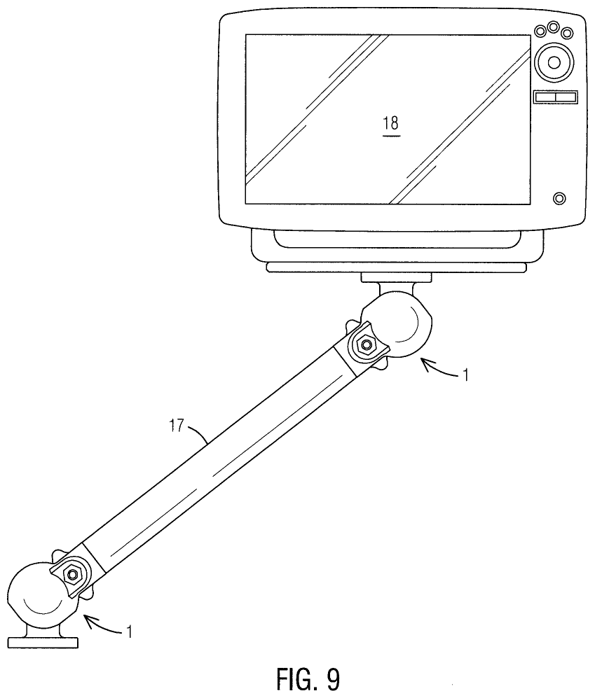

With reference to FIG. 9, an exemplary view of multiple ball and socket joints 1 of the present invention in use with a mounting system for a digital display 18 is illustrated. Ball and socket joints 1 of the present invention are located on opposing ends of a support arm 17 that may be mounted to a surface of a vehicle or boat to support a digital display 18. The arm 17 may be angled and rotated into multiple positions and then securely locked into position.

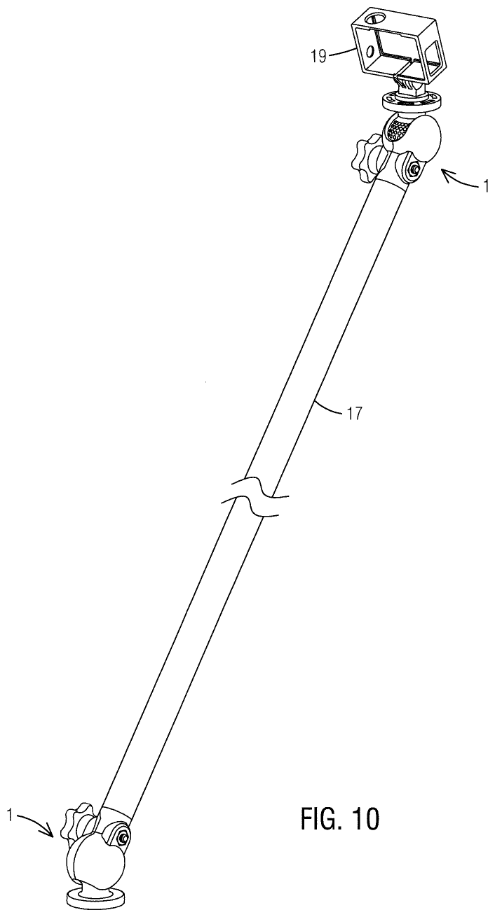

Finally, with reference to FIG. 10, an exemplary view of multiple ball and socket joints 1 of the present invention in use with a mounting system for a holding a camera 19 in an elevated position is illustrated. Ball and socket joints 1 of the present invention are located on opposing ends of an elongated or telescoping support arm 17 that may be mounted to a surface. The arm 17 may be angled and rotated into multiple positions and then securely locked into position.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A locking ball and socket joint comprising:
a ball having a spherical-shaped body with an outer surface;
said ball being inserted into a concave-shaped socket;
said socket having an inner surface that engages the outer surface of said spherical-shaped body; and
a clamping means located on said concave-shaped socket to tighten the socket around the ball and press the outer surface of the spherical-shaped body against the inner surface of the socket to form interlocking surfaces between the ball and the socket.

2. The locking ball and socket joint of claim 1 wherein:
said interlocking surfaces formed between the ball and the socket are formed by an engagement of at least one projection and at least one void located between the ball and the socket.

3. The locking ball and socket joint of claim 2 wherein:
said at least one projection is a dimple-shaped projection; and
said at least one void is a dimple-shaped void.

4. The locking ball and socket joint of claim 2 wherein:
said at least one void is a groove-shaped void.

5. A locking ball and socket joint comprising:
a ball having a spherical-shaped body with an outer surface;
said ball being inserted into a concave-shaped socket;
said socket having an inner surface that engages the outer surface of said spherical-shaped body;
a clamping means located on said concave-shaped socket to tighten the socket around the ball and press the outer surface of the spherical-shaped body against the inner surface of the socket to form interlocking surfaces between the ball and the socket; and
said interlocking surfaces formed between the ball and the socket are formed by an engagement of at least one projection and at least one void located between the ball and the socket.

6. The locking ball and socket joint of claim 5 wherein:
said at least one projection is a dimple-shaped projection; and
said at least one void is a dimple-shaped void.

7. The locking ball and socket joint of claim 5 wherein:
said at least one void is groove-shaped void.
